(19) United States
(12) Patent Application Publication
(10) Pub. No.: US 2010/0053623 A1
(43) Pub. Date: Mar. 4, 2010

(54) MEMBRANE AND FABRICATION METHOD THEREOF

(76) Inventors: Sunghoon Kwon, Seoul (KR); Junhoi Kim, Seoul (KR)

Correspondence Address: Sunghoon Kwoon;Faculty APT 122I-104, San 4-2, Bongchun 7 Dong, Gwanak-Gu, Seoul, KR

(21) Appl. No.: 12/199,606

(22) Filed: Aug. 27, 2008

(51) Int. Cl. G01N 21/63; B32B 3/10; B32B 3/30; B05D 5/06

(52) U.S. Cl. 356/445; 428/131; 428/137; 427/162; 428/120; 204/192.15; 205/238; 430/321

(57) ABSTRACT

Disclosed are membranes including a nanohole penetrating the membrane and two opposing faces. Method of making the membranes are also disclosed.

### BACKGROUND

Plasmons in a metal are vibrational modes of the electron gas density oscillating about the metallic ion cores. Surface plasmons are the special case in which the charges are confined to the surface of the metal. Surface plasmons, which may be excited by light, are exploited in a variety of optical devices, including microscopes, solar cells, and molecular sensors. However, the transmission efficiency and sensitivity of many conventional surface plasmon based devices can be limited.

### SUMMARY

In one embodiment, a membrane having two opposing faces comprises at least one nanohole penetrating the membrane. The first face comprises a collection of indentations arranged to enhance the transmission of light through the nanohole and the second face comprises a collection of protrusions arranged to enhance the excitation of surface plasmons from the membrane. The first face, the second face, or both faces can comprise one or more metals. The first face can comprise a dielectric material and the second face can comprise one or more metals.

The dielectric material may be selected from silicon oxide, silicon nitride, glass, titanium oxide (TiO₂), tantalum oxide (Ta₂O₅), aluminum oxide (Al₂O₅), or quartz. The metal may be selected from gold, silver, platinum, copper, or aluminum. The indentations may be arranged to form concentric circles surrounding the nanohole. The indentations may be arranged to form a lattice surrounding the nanohole. The protrusions can comprise a tip pointed toward the nanohole. The collection of protrusions may comprise one or more pairs of protrusions arranged symmetrically about the center of the nanohole. The collection of protrusions may comprise one pair of protrusions arranged symmetrically about the center of the nanohole. The collection of protrusions may comprise two pairs of protrusions. The first pair is arranged symmetrically on a first axis intersecting the center of the nanohole and the second pair is arranged symmetrically on a second axis intersecting the center of the nanohole. The first and second axes form a right angle at the center of the nanohole. The distance between the protrusions in the first pair is substantially the same as the distance between the protrusions in the second pair.

The membrane may further comprise a layer of dielectric material disposed on the second face of the membrane. The dielectric material may not cover the nanohole. The protrusions may comprise a tip pointed toward the nanohole and the dielectric material may not cover the tip. The first face may comprise a first dielectric material, a second dielectric material may be disposed on the second face, and the first and second dielectric materials may have substantially the same dielectric constants.

In another embodiment, an apparatus for the detection of one or more molecules comprises a membrane having two opposing faces. The membrane comprises at least one nanohole penetrating the membrane. The first face comprises a collection of indentations arranged to enhance the transmission of light through the nanohole, and the second face comprises a collection of protrusions arranged to enhance the excitation of surface plasmons from the membrane. The one or more molecules may be biomolecules. The apparatus may further comprise an electromagnetic energy source configured to illuminate the membrane. The apparatus may further comprise an optical detection unit configured to detect an optical signal from the membrane.

In yet another embodiment, a method of fabricating a membrane for the detection of one or more molecules comprises forming a collection of indentations on a first face of the membrane, the indentations arranged to enhance the transmission of light through the membrane, and forming a collection of protrusions on a second face of the membrane, the protrusions arranged to enhance the excitation of surface plasmons from the membrane. The method may further comprise forming a metal layer to provide the membrane. The method may further comprise forming a dielectric layer and a metal layer on the dielectric layer to provide the membrane. The metal layer may be formed by evaporation, sputtering or electroplating. The collection of indentations or/and the collection of projecting portions may be formed by performing focused ion-beam lithography, e-beam lithography, proximal probe patterning, X-ray lithography, or extreme-UV lithography. The method of fabricating a membrane for the detection of one or more molecules may further comprise forming a nanohole through the membrane.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a schematic sectional view of illustrative embodiment of a membrane.

FIGS. 2a and 2b show schematic plan views of illustrative embodiments of a patterns for a collection of indentations on a first face of a membrane.

FIG. 3 shows a schematic of an illustrative embodiment of a graph comparing light transmission through a nanohole of a membrane having no indentations (1) and a membrane having indentations (2).

FIGS. 4a through 4d show schematic plan views of illustrative embodiments of a pattern for a collection of protrusions on a second face of a membrane.

FIG. 5 shows schematic sectional view of illustrative embodiment of a membrane having a dielectric material disposed on a second face of the membrane.

FIG. 6 shows a schematic of an illustrative embodiment of a graph illustrating light transmission of membranes having the first face formed of a first dielectric material and a second dielectric material disposed on the second face of the membrane.

FIG. 7 shows a schematic of an illustrative embodiment of an apparatus for the detection of molecules including a membrane.

FIGS. 8a through 8c show schematic sectional views of illustrative embodiments of a method of fabricating a membrane.

FIGS. 9a through 9e show schematic sectional views of illustrative embodiments of a method of fabricating a membrane.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present technology relates to membranes for the detection of one or more molecules using surface plasmons. The membranes are capable of enhancing the transmission of light through one or more nanoholes penetrating the membranes, and of enhancing the excitation of surface plasmons from the membranes. Because of the enhancement of light transmission and excitation of surface plasmons, the membranes are highly sensitive. Also disclosed are methods for making the membranes and apparatuses incorporating the membranes. These apparatuses are more sensitive than conventional surface plasmon based devices.

The membranes disclosed herein have two opposing faces and at least one nanohole penetrating the membrane. The dimensions of the nanohole may vary. By way of example, the average diameter of the nanohole is about 300 nm or less, particularly about 100 nm or less, more particularly about 20 nm or less. By way of background, the transmission of light through apertures smaller than the wavelength of light falls as (d/λ)⁴. Accordingly, a first face of the disclosed membranes is configured to enhance the transmission of light through the nanohole. Also by way of background, light illuminating a nanohole may generate, and resonantly couple to, surface plasmons at a metal-dielectric interface. Therefore, a second face of the disclosed membranes is configured to enhance the excitation of these surface plasmons by the incident light.

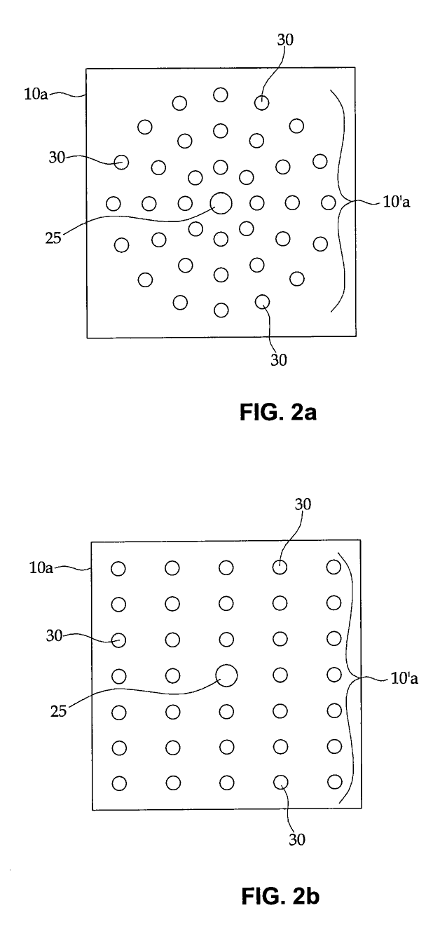

In some aspects, the first face of the membrane comprises a collection of indentations arranged to enhance the transmission of light through the nanohole. The indentations may arranged in a variety of patterns on the surface of the membrane, provided the collection of indentations enhances the transmission of light through the nanohole. In some aspects, the indentations are arranged to form concentric circles surrounding the nanohole. In other aspects, the indentations are arranged to form a lattice surrounding the nanohole. Non-limiting examples of such patterns are shown in FIG. 2 and are further described below. These, and other patterns of indentations, effectively focus the optical field generated by incident light towards the nanohole, thus increasing the transmission of the light through the nanohole. This is because light transmission efficiency depends on the coupling to the incident photons afforded by surface features (e.g., the indentations) and not by only a nanohole. The dimensions of the indentations themselves may vary. In one embodiment, the average diameter of the indentations is about 300 nm or less, particularly about 100 nm or less, more particularly about 20 nm or less Similarly, the distance between adjacent indentations may vary. In one embodiment, the distance between adjacent indentations is in a range of about 0.01 μm-100 μm, particularly about 0.1 μm-10 μm, more particularly about 0.5 μm-1 μm. Similarly, the distance between the nanohole and the adjacent indentations is in a range of about 0.01 μm-100 μm, particularly about 0.1 μm-10 μm, more particularly about 0.5 μm-1 μm.

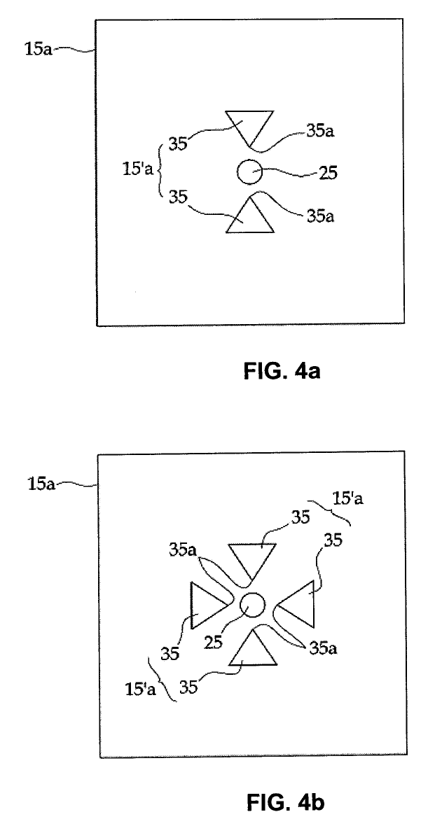

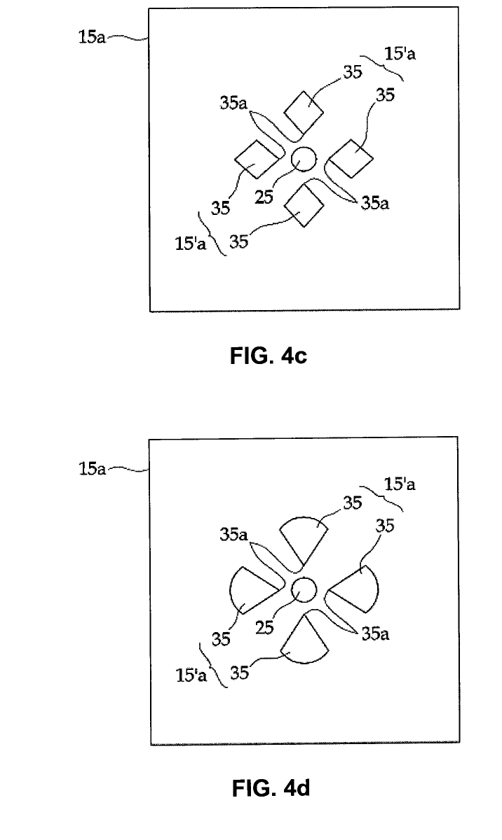

In further aspects, the second face of the membrane comprises a collection of protrusions arranged to enhance the excitation of surface plasmons from the membrane. The protrusions may be arranged in a variety of patterns on the surface of the membrane, provided the collection of protrusions enhances the excitation of surface plasmons from the membrane. In some aspects, the collection comprises one or more pairs of protrusions arranged symmetrically about the center of the nanohole. Non-limiting examples of such patterns are shown in FIG. 4 and are further described below. The shape of the protrusions may vary. In some aspects, the protrusions comprise a tip pointed towards the nanohole. Non-limiting examples of shapes comprising a tip include a triangle, a rhombus and a sector. These patterns and shapes, as well as others, serve to enhance the intensity of an electric field between the protrusions, thereby enhancing the excitation of surface plasmons from the membrane. The dimensions of the protrusions may vary. In one embodiment, the distance from the midpoint of the protrusion shape to its apex or edge is in a range of about 1 nm to 500 nm, particularly about 10 nm to 200 nm, more particularly about 50 nm to 100 nm. In one embodiment, the gap distance between the facing tips of the protrusions is in a range of about 1 nm to 1000 nm, particularly 10 nm to 700 nm, more particularly 16 nm to 500 nm. Similarly, the distance between adjacent protrusions may vary. In one embodiment, the distance between the adjacent protrusions is in a range about 10 nm to 100 μm, particularly about 1 μm to 50 μm, more particularly about 5 μm to 15 μm.

The first and second faces of the membrane may comprise a variety of materials. In some aspects, the first face, the second face, or both faces comprise one or more metals. In some aspects, both faces comprise one or more metals. In such aspects, the membrane is effectively a metal layer. A variety of metals may be used, provided surface plasmons can be generated in the metal. Non-limiting examples of such metals include gold, silver, platinum, copper, and aluminum. In other aspects, the first face comprises a dielectric material. A variety of dielectric materials may be used, including, but not limited to silicon oxide, silicon nitride, glass, titanium oxide (TiO₂), tantalum oxide (Ta₂O₅), aluminum oxide (Al₂O₅), and quartz. In yet further aspects, the first face comprises a dielectric material and the second face comprises one or more of any of the metals disclosed herein. In such aspects, the membrane is effectively a layer of dielectric material in substantial contact with a layer of metal.

The thicknesses of each face of the membrane, and thus, the thickness of the membrane itself, may vary. The membrane may have a thickness of about 500 nm or less, particularly about 100 nm or less, more particularly about 10 nm to 50 nm. In one embodiment, the membrane may have a circular periphery, a polygonal periphery such as a square periphery or any other peripheral configuration.

In further aspects, any of the membranes disclosed herein comprise a dielectric material disposed on the second face of the membrane. The dielectric material forms one or more layers covering the surface of the second face of the membrane. However, in some aspects, portions of the surface of the second face are not covered by the dielectric material. In some aspects, the dielectric material does not cover the nanohole. In other aspects, the dielectric material does not cover the protrusions on the surface of the second face. In yet other aspects, the dielectric material covers some portions of the protrusions, but not other portions. In such aspects, the protrusions may comprise a tip pointed towards the nanohole and the dielectric material does not cover the tip.

A variety of dielectric materials may be used to form the layer disposed on the second face of the membrane, including, but not limited to any of the dielectric materials disclosed above. In some aspects, the first face of the membrane comprises a first dielectric material, one or more layers of a second dielectric material disposed on the second face of the membrane, and the first and second dielectric materials have substantially the same dielectric constant. The phrase “substantially the same” is used to encompass aspects in which the first and second dielectric materials are different, but have similar dielectric constants. In other aspects, the first and second dielectric materials are the same material, and thus have the same dielectric constants. As further described below, a further enhancement in light transmission through the nanohole may be achieved when the first and second dielectric materials are the same material.

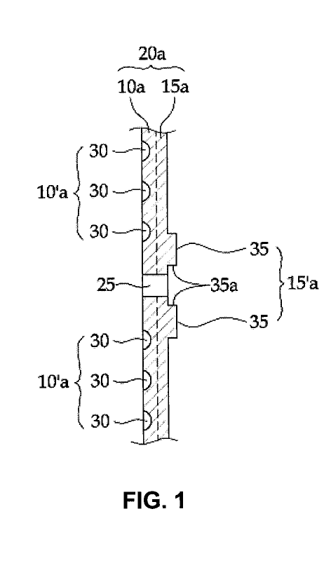

FIGS. 1-11 depict illustrative embodiments of the membranes described above. FIG. 1 shows a cross-section of a membrane 20a having a first face 10a, a second face 15a opposite to the first face, and a nanohole 25 penetrating the membrane. The first face comprises a collection 10a′ of indentations 30 on the surface of the first face. The second face comprises a collection 15a′ of protrusions 35 on the surface of the second face. The protrusions 35 comprise a tip 35a. In this aspect, the cross-section shows a pair of protrusions, although the second face may comprise more pairs of protrusions as described above.

As described above, the indentations on a first face of a membrane may be arranged in a variety of patterns. Non-limiting examples of such patterns are depicted in FIG. 2. FIGS. 2a and 2b depict the front face 10a of a membrane having a nanohole 25. In FIG. 2a, the indentations 30 form concentric circles surrounding the nanohole. In FIG. 2b, the indentations 30 form a lattice surrounding the nanohole.

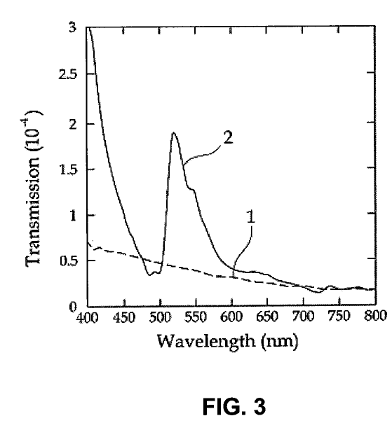

FIG. 3 depicts the enhancement of light transmission through a nanohole achieved by a collection of indentations on the surface of a first face of a membrane. Both the first face and opposing second face of the membrane of FIG. 3 are silver, and the indentations in the first face form a lattice surrounding the nanohole having the distance between the adjacent indentations is about 0.5 μm. Curve 1 is the transmission spectrum at the nanohole for a membrane having no indentations on its first face. Curve 2 is the transmission spectrum at the nanohole for a membrane having a collection of indentations on its first face. As illustrated, the transmission of light is greater in curve 2 for many wavelengths of light compared to curve 1.

FIG. 4 illustrates a variety of patterns of protrusions on a second face of a membrane are depicted. FIGS. 4a-4d shows a second face of a membrane 15a having a nanohole 25 and a collection 15a′ of protrusions 35 disposed on the surface of the second face. The figures depict various shapes of protrusions, including a triangle (FIGS. 4a and 4b), a rhombus (FIG. 4c) and a sector (FIG. 4d), each which comprises a tip 35a pointed towards the nanohole 25. In FIG. 4a, a pair of protrusions is arranged symmetrically about the center of the nanohole 25. As such, the pair forms a “bow-tie” structure. In FIGS. 4b-4d, two pairs of protrusions are arranged symmetrically about the center of the nanohole. In these figures, one pair is arranged symmetrically on a first axis intersecting the center of the nanohole, the second pair is arranged symmetrically on a second axis intersection the center of the nanohole, and the first and second axes form a right angle at the center of the nanohole. However, the first and second axes may form a variety of other angles, including but not limited to, between 30° and 150°, particularly between 45° and 145°, more particularly about 90°. Also in FIGS. 4b-4d, the distance between the protrusions in the first pair is substantially the same as the distance between the protrusions in the second pair. However, in other aspects, the distances may be different.

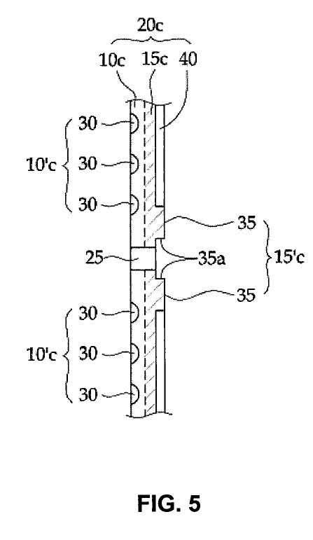

FIG. 5 depicts another illustrative embodiment of a membrane. The membrane 20c includes a first face 10c, a second face 15c opposite to the first face, and a nanohole 25 penetrating the membrane. The first face comprises a collection 10c′ of indentations 30 on the surface of the first face. The second face comprises a collection 15c′ of protrusions 35 on the surface of the second face. The protrusions 35 comprise a tip 35a. The membrane 20c further includes a layer 40 of a dielectric material disposed on the second face 15c of the membrane. In this aspect, the layer 40 contacts, but does not cover, the protrusions 35.

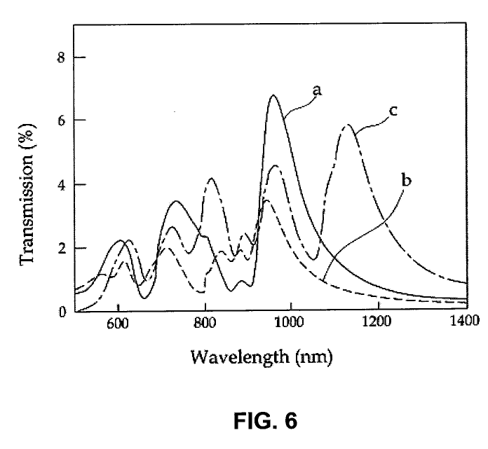

FIG. 6 illustrates the light transmission spectrum through a nanohole in membranes having a layer of a dielectric material disposed on the second face of the membrane. In the membranes of FIG. 6, the first face of the membrane is quartz and the second face is a silver. Curve “a” is the light transmission spectrum for the membrane in which the dielectric constant ∈_{L} of the dielectric material disposed on the second face of the membrane is the same as the dielectric constant ∈_{S} of the first face of the membrane (∈_{L}=∈_{S}). Curve “b” is the light transmission spectrum for the membrane in which the dielectric constant ∈_{L} of the dielectric material disposed on the second face of the membrane is the less than the dielectric constant ∈_{S} of the first face of the membrane (∈_{L}<∈_{S}). Curve “c” is the light transmission spectrum for the membrane in which the dielectric constant ∈_{L} of the dielectric material disposed on the second face of the membrane is the greater than the dielectric constant ∈_{S} of the first face of the membrane (∈_{L}>∈_{S}). As illustrated, the peak of the transmission spectrum for the membrane of curve “b” is smaller than the peaks for the membranes of curve “a” and curve “c.” The membrane of curve “c” exhibits a peak at longer wavelengths that is comparable to the peak for the membrane of curve “a.” Thus, transmission efficiency may be increased by a membrane having a first face comprising a first dielectric material, a second dielectric material disposed on the second face of the membrane, wherein the first and second dielectric materials have substantially the same dielectric constants.

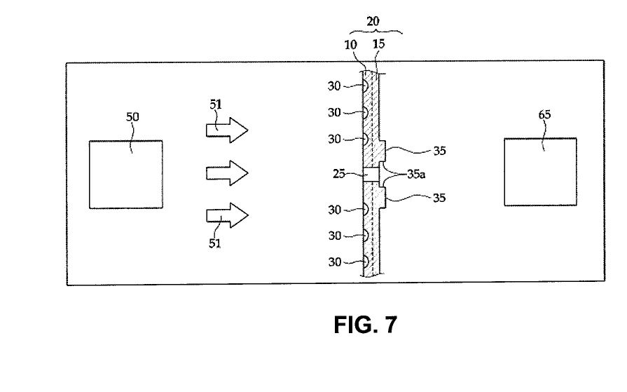

Also disclosed herein are apparatuses incorporating any of the membranes described herein. The apparatuses may be used for the detection of one (i.e., single) or more molecules. In some aspects, the molecules may be biomolecules. Referring to FIG. 7, the apparatus may include an electromagnetic energy source 50, a membrane 20, and an optical detection unit 65. The electromagnetic energy source 50 is configured to illuminate the first face 10 of the membrane 20 with electromagnetic energy 51. A variety of types of electromagnetic energy may be used, including, but not limited to X-rays, visible light rays, infrared rays, or UV rays. The collection of indentations 30 on the surface of the first face focuses the optical field generated by incident light towards the nanohole, thus increasing the transmission of the light through the nanohole. The second face 15 of the membrane includes a collection of protrusions 35. As described above, the protrusions are arranged to enhance the excitation of surface plasmons from the membrane. The optical detection unit 65 is configured to detect an optical signal from the membrane. An optical signal may be generated when a molecule passes through the nanohole. The optical detection unit 65 may detect, but not limited to, fluorescence or the Raman scattering signal of the molecule. The optical detection unit 65 can comprise, but not limited to, an optical microscope or a confocal microscope. In some embodiments, the optical detection unit 65 may include a processor (not illustrated) for processing, analyzing, storing, or transmitting the optical information of a target included in a sample. Alternatively, a processor may be provided independently from the optical detection unit 65. In some embodiments, the processor may be connected to the optical detection unit 65 and can process, analyze, store or transmit the optical information detected by the optical detection unit 65. The processor may include a computer.

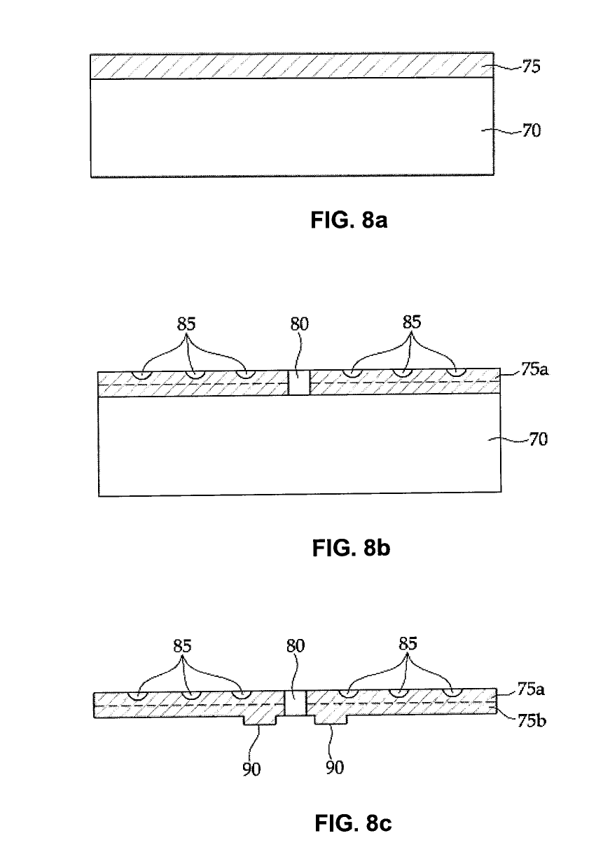

Also disclosed herein are methods for forming any of the membranes described above. These methods are described in reference to FIGS. 8-10. FIG. 8 illustrates a method of fabricating a membrane having a first and second face made of metal. As shown in FIG. 8a, a metal layer 75 is formed on a substrate 70. A variety of substrate materials may be used, including, but not limited to quartz. The metal layer 75 may be formed by a variety of well-known techniques, including, but not limited to, sputtering, electroplating, e-beam evaporation, thermal evaporation, laser-induced evaporation, or ion-beam induced evaporation. As shown in FIG. 8b, a nanohole 80 and a collection of indentations 85 are formed in the metal layer 75. The nanohole and indentations may be formed by a variety of well-known techniques, including, but not limited to focused ion-beam lithography, e-beam lithography, proximal prove patterning, X-ray lithography, and extreme-UV lithography. One or more appropriately patterned masks may be used to form the indentations and nanoholes without removing the rest of the metal layer. The dimensions of the nanohole and indentations may be varied by controlling the various conditions and time of the etching process. As shown in FIG. 8c, the substrate 70 is removed using well-known etching processes in order to expose the other face of the metal layer 75. Subsequently, protrusions 90 are formed on the exposed surface of the metal layer 75 using focused ion-beam lithography, e-beam lithography, proximal prove patterning, X-ray lithography, or extreme-UV lithography. By way of example, a shaped mask having a pattern corresponding to desired protrusions 90 can be used.

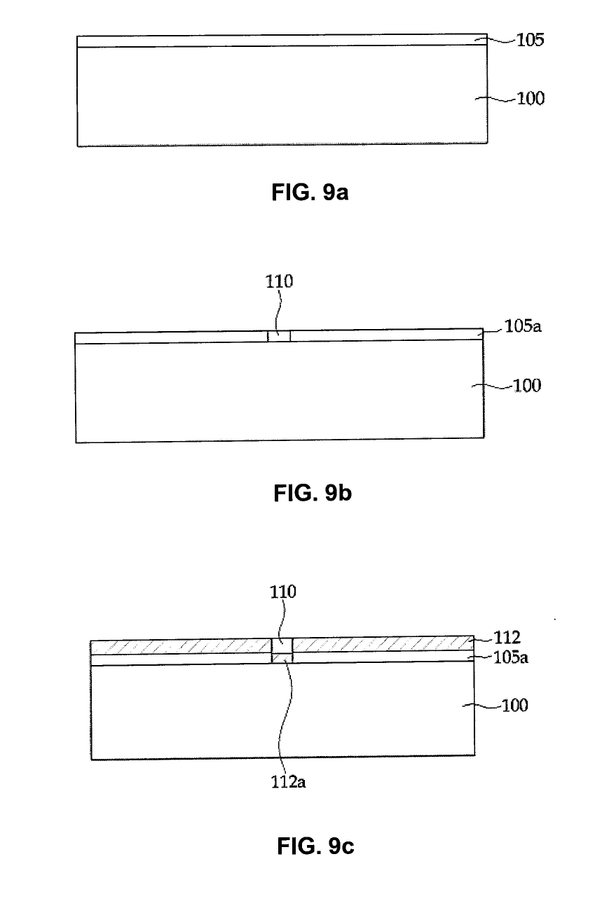

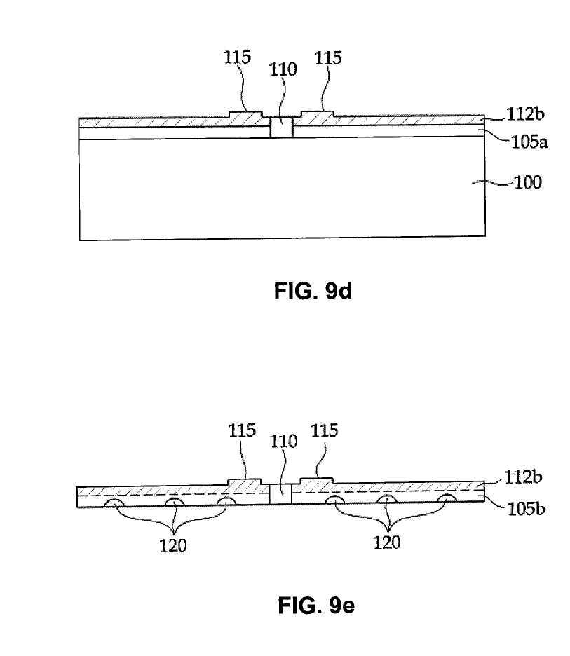

FIG. 9 illustrates a method of fabricating a membrane having a first face made of a dielectric material and second face made of metal. As shown in FIG. 9a, a dielectric layer 105 is formed on a substrate 100. Any of the dielectric materials and substrate materials described above may be used. As shown in FIG. 9b, a nanohole 110 penetrating the dielectric layer 105 is formed using any of the techniques for forming nanoholes described above. The dielectric layer 105 having the nanohole 110 is labeled 105a. As shown in FIG. 9c, a metal layer 112 is formed on the layer 105a using any of the techniques for forming metal layers described above. The formation of the metal layer 112 may cause a layer of metal 112a to be deposited in the nanohole, which can be subsequently removed by etching. As shown in FIG. 9d, protrusions 115 on the metal layer 112 may be formed by any of the methods for forming protrusions described above. The metal layer having the nanohole 110 and the protrusions 115 is labeled 112b. As shown in FIG. 9e, the substrate 100 is removed by any of the etching techniques described above in order to expose the layer 105a. Indentations 120 may be formed on the surface of the exposed layer 105a, by any of the techniques for forming indentations described above.

In a variation of the method illustrated in FIG. 9, no nanohole may be formed in the dielectric layer 105. Instead, a nanohole 110 may be formed in both the metal layer 112 and the dielectric layer 105 after the metal layer 112 is deposited, after the protrusions 115 are formed, or after the indentations 120 are formed.

In yet another variation of the method illustrated in FIG. 9, the substrate may be made of any of the dielectric materials disclosed herein and the formation of a separate dielectric layer on the substrate may be omitted. Instead, the substrate may be etched until it becomes thin enough to be used as the dielectric layer.

Any of the disclosed methods may further comprise forming a layer of a dielectric material on the second face of the membrane. By way of example only, after the process illustrated in FIG. 9d, a second dielectric layer may be formed over the layer 112b by any of the techniques for forming a dielectric layer described above. This second dielectric layer may be etched in order to expose the nanohole 110, the protrusions 115, or just the tips of the protrusions.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A membrane having two opposing faces, the membrane comprising at least one nanohole penetrating the membrane, wherein the first face comprises a collection of indentations arranged to enhance the transmission of light through the nanohole and the second face comprises a collection of protrusions arranged to enhance the excitation of surface plasmons from the membrane.

2. The membrane of claim 1, wherein the first face, the second face, or both faces comprise one or more metals.

3. The membrane of claim 1, wherein the first face comprises a dielectric material and the second face comprises one or more metals.

4. The membrane of claim 3, wherein the dielectric material is selected from silicon oxide, silicon nitride, glass, titanium oxide (TiO₂), tantalum oxide (Ta₂O₅), aluminum oxide (Al₂O₅), and quartz.

5. The membrane of claim 3, wherein the metal is selected from gold, silver, platinum, copper, and aluminum.

6. The membrane of claim 1, wherein the indentations are arranged to form concentric circles surrounding the nanohole.

7. The membrane of claim 1, wherein the indentations are arranged to form a lattice surrounding the nanohole.

8. The membrane of claim 1, wherein the protrusions comprise a tip pointed towards the nanohole.

9. The membrane of claim 1, wherein the collection of protrusions comprises one or more pairs of protrusions arranged symmetrically about the center of the nanohole.

10. The membrane of claim 9, wherein the collection of protrusions comprises one pair of protrusions arranged symmetrically about the center of the nanohole.

11. The membrane of claim 9, wherein the collection of protrusions comprises two pairs of protrusions, wherein the first pair is arranged symmetrically on a first axis intersecting the center of the nanohole and the second pair is arranged symmetrically on a second axis intersecting the center of the nanohole and the first and second axes form a right angle at the center of the nanohole, and further wherein the distance between the protrusions in the first pair is substantially the same as the distance between the protrusions in the second pair.

12. The membrane of claim 1, further comprising a layer of dielectric material disposed on the second face of the membrane.

13. The membrane of claim 12, wherein the dielectric material does not cover the nanohole.

14. The membrane of claim 13, further wherein the protrusions comprise a tip pointed towards the nanohole and the dielectric material does not cover the tip.

15. The membrane of claim 1, wherein the first face comprises a first dielectric material, a second dielectric material is disposed on the second face, and the first and second dielectric materials have substantially the same dielectric constants.

16. An apparatus for the detection of one or more molecules, the apparatus comprising a membrane having two opposing faces, the membrane comprising at least one nanohole penetrating the membrane, wherein the first face comprises a collection of indentations arranged to enhance the transmission of light through the nanohole and the second face comprises a collection of protrusions arranged to enhance the excitation of surface plasmons from the membrane.

17. The apparatus of claim 16, wherein the one or more molecules are biomolecules.

18. The apparatus of claim 16, further comprising an electromagnetic energy source configured to illuminate the membrane.

19. The apparatus of claim 18, further comprising an optical detection unit configured to detect an optical signal from the membrane.

20. A method of fabricating a membrane for the detection of one or more molecules, the method comprising:
forming a collection of indentations on a first face of the membrane, the indentations arranged to enhance the transmission of light through the membrane; and
forming a collection of protrusions on a second face of the membrane, the protrusions arranged to enhance the excitation of surface plasmons from the membrane.

21. The method of claim 20, further comprising forming a metal layer to provide the membrane.

22. The method of claim 20, further comprising forming a metal layer on a dielectric layer to provide the membrane.

23. The method of claim 21 wherein the metal layer is formed by evaporation, sputtering or electroplating.

24. The method of claim 20, wherein the collection of indentations and the collection of projecting portions are formed by focused ion-beam lithography, e-beam lithography, proximal probe patterning, X-ray lithography, or extreme-UV lithography.

25. The method of claim 20, further comprising forming a nanohole through the membrane.
